(19) United States
(12) Patent Application Publication
(10) Pub. No.: US 2024/0309930 A1
(43) Pub. Date: Sep. 19, 2024

(54) SMART MAGNETIC VALVE WITH INTEGRATED ELECTRONICS

(71) Applicant: RAPA Automotive GmbH & Co. KG, Selb (DE)

(72) Inventors: Rocco KEMNITZ, Selb (DE); Roman PAUSCH, Selb (DE)

(73) Assignee: RAPA Automotive GmbH & Co. KG, Selb (DE)

(21) Appl. No.: 18/591,151

(22) Filed: Feb. 29, 2024

(30) Foreign Application Priority Data
Mar. 14, 2023 (DE) 102023106342.1

(51) Int. Cl. F16F 9/34; B60G 11/27; B60G 17/052; F16F 9/02; F16F 9/50; F16K 31/06; F16K 31/08; G05D 16/20

(52) U.S. Cl. CPC F16F 9/34; F16F 9/0218; F16F 9/029; F16F 9/50; F16K 31/0675; F16K 31/08; G05D 16/20; B60G 11/27; B60G 17/0528; B60G 2202/152; B60G 2204/62; B60G 2206/42; B60G 2500/201; B60G 2500/204; B60G 2600/182; B60G 2800/162; B60G 2800/916; F16F 2222/126; F16F 2228/066

(57) ABSTRACT

A magnetic valve unit comprising a magnetic valve and an electronics for driving the magnetic valve. A pneumatic spring and a pneumatic spring system.

### FIELD

The present invention relates to a magnetic valve unit, in particular a pneumatic valve, a pneumatic spring and a pneumatic spring system of a motor vehicle.

### BACKGROUND

It is known to employ magnetic valves for fluids, that is pneumatic and/or hydraulic magnetic valves, for example in multi-chamber pneumatic springs or shock absorbers, in order to connect an additional air volume to a base air volume or separate it therefrom and to thus change the shock-absorption properties of the pneumatic spring. A usually central drive and regulation device, such as an axle control or chassis control device, that is allocated to the magnetic valves of the different pneumatic springs of a vehicle provides one electric supply line per magnetic valve for the energization of the respective magnetic coil. However, multi-chamber pneumatic springs with three or more pneumatic chambers are also known, in which correspondingly two or more magnetic valves are provided, so that a correspondingly large number of electric supply lines must be provided.

### SUMMARY

It is an object of the invention to simplify the regulation of the magnetic valves and to reduce the wiring effort, in particular in the case of employment in pneumatic springs and/or multi-chamber pneumatic springs in vehicles.

The magnetic valve unit according to the invention comprises a magnetic valve and an (integrated) electronics, which is preferably set up for driving the magnetic valve and/or comprises or consists of exactly one, two or several sensor(s), particularly preferably exactly one, two or several pressure sensor(s).

The magnetic valve unit according to the invention is a pre-assembled, independent and/or compact construction group or construction unit, which comprises the magnetic valve and the electronics or consists thereof, so that the electronics is integrated (constructively) in the magnetic valve unit, i.e. forms an integrated or constructively integrated electronics. The magnetic valve unit thus consists of a magnetic valve with a (constructively integrated) electronics in the simplest case, wherein the electronics is set up for driving the magnetic valve or its electric construction elements (drive electronics) and/or comprises or consists of one or several sensor(s), in particular one or two pressure sensor(s).

The magnetic valve unit according to the invention preferably has a casing (magnetic-valve unit casing), which encloses the magnetic valve and the electronics and forms a common casing. Said magnetic-valve unit casing usually consists of two or several parts or partial casings and forms, when used as intended, a composite and/or common construction element or casing. Two, several or all partial casings can be interconnected inseparably here (single-part casing). The magnetic-valve unit casing is preferably closed and/or waterproof, splash-waterproof and/or airtight, and/or the magnetic-valve unit casing preferably has (only or exactly) the fluid connectors and electric connectors and/or interfaces as described in the following.

The magnetic valve unit and/or the magnetic-valve unit casing preferably has (exactly) two fluid connectors, preferably a radial connector and an axial connector, which form a fluid inlet and/or a fluid outlet depending on the flow direction of the fluid. The magnetic valve is preferably set up as a pneumatic magnetic valve or also as a hydraulic magnetic valve. The magnetic valve unit and/or the magnetic-valve unit casing further preferably has (exactly) two (outwardly disposed or arranged in the casing) electric connectors (for example socket, plug, plug-in socket, cable). The electric connectors are preferably a supply voltage connector for a supply voltage (usually a continuously applied direct voltage of 12 V, 24 V or 48 V) and a control or bus connector for a control line, for example a bus or standard bus, such as a CAN bus (controller area network), LIN bus (local interconnect network), CAN-FD bus or Flexray bus. The magnetic valve unit and/or the magnetic-valve unit casing particularly preferably do not have any further fluid connectors or electric connectors or interfaces in addition.

The supply voltage is delivered, for example, by a vehicle on-board network (general voltage supply) and the supply voltage connector is preferably bipolar. The control connector is a control and/or communication connector, via which preferably exclusively (powerless) control signals (for example from a superordinate control device or a communication partner on the bus) are transmitted, and the control connector is preferably laid out only for powerless control signals or control voltages. The control connector is preferably an interface for a standard bus in vehicles, such as a CAN or LIN bus, and is, for example, unipolar or bipolar and/or two-, three- or four-core. Moreover, the magnetic-valve unit casing can also have predetermined mechanical interfaces (lugs, grooves, depressions, etc.) and/or sealing means, for mechanical mounting and/or for sealing, for example in a predefined installation situation.

The electronics of the magnetic valve unit in a variant according to the invention is set up for (electrically) driving the magnetic valve, in particular for driving all electric and/or electromagnetic components of the magnetic valve. The electronics correspondingly delivers the complete energization, i.e. all drive and control voltages and currents, for the magnetic valve. Correspondingly, preferably all electric supply lines of the magnetic valve lead (exclusively) to the electronics.

The electronics is preferably configured as an electronic unit, i.e. as a construction unit, in which the different, preferably all components or construction elements or electronic construction elements of the (constructively integrated) electronics are arranged, preferably in compact or space-saving manner and/or on (exactly) one circuit board or on two or several circuit boards. The electronic construction elements are preferably integrated electronic construction elements or IC elements (integrated circuit, IC). In the simplest case, the electronics comprises exclusively integrated electronic construction elements and/or exactly one integrated electronic construction element or consists thereof.

The magnetic valve has at least one magnetic coil, preferably exactly one magnetic coil, particularly preferably as the only electric or electromagnetic component. The electronics or the electronic unit is then set up to deliver, emit and/or generate the coil current or all switching and/or holding currents for the magnetic coil for approaching and optionally holding switching positions or end positions, and to thus (electrically) drive the magnetic valve.

Correspondingly, the electronics or the electronic unit is then preferably electrically connected directly and immediately to the magnetic coil of the magnetic valve and there are correspondingly no electric construction elements or switching units located between the electronics or electronic unit and the magnetic coil. For example, a total of (only) exactly two single-core electric supply lines extend between the electronics and the magnetic valve, each of which leading directly to one of the two connectors of the magnetic coil.

Further, the electronics or electronic unit preferably has all (outwardly disposed or external) electric connectors of the magnetic valve unit or of the magnetic-valve unit casing (for example socket, plug, plug-in sockets, cable). Correspondingly, the electronics or electronic unit preferably has (exactly) one electric connector for the supply voltage and (exactly) one electric connector for the control line or the bus. Proceeding from control signals of the control line, for example information via the bus, the electronics thus controls the magnetic valve and, in the simplest case, generates all drive currents for the magnetic valve with the aid of the supply voltage.

The electronics correspondingly has preferably a control logic, comprising in particular a microprocessor or an ASIC (application-specific integrated circuit), which is set up to work, for example, as a bus participant or generally as receiver and/or emitter for control signals via the control line. The control logic is further set up, for example, to predetermine the duration and the level of energization of the magnetic coil and/or to take a decision about the triggering of switching processes or the emission of switching currents, for example on the basis of general provisions of a superordinate control device connected via the control line. Correspondingly, the electronics or the electronics unit is a smart unit.

Further, the electronics preferably has a power electronics, which is set up, proceeding from the supply voltage, to generate all drive currents and voltages, in particular the coil current or all coil currents of the magnetic coil of the magnetic valve, such as switching current and/or holding current. In the simplest case, the electronics is set up to generate the energization of the magnetic coil of the magnetic valve, i.e. the coil current, in particular switching current and optionally also the holding current, by (simply) connecting through the supply voltage, so that, in the simplest case, the electronics is set up to switch or to apply the supply voltage, for a predetermined duration, directly or immediately to the supply lines of the magnetic coil. The magnetic coil has, for example, an ohmic resistance between 4 and 8 Ohm, in particular of 6 Ohm, so that there results, for example, a current of 2 A from an applied supply voltage of 12 V.

When the electronics is executed as an electronic unit, i.e. as a construction unit, the electronic unit is preferably directly and immediately arranged on the magnetic valve (which forms a (further) construction unit of the magnetic valve unit) and fixedly connected thereto (for example via screwing, welding, snap-on, crimp and or adhesive connections). The electronic unit preferably further comprises a (closed or open, single-piece or multi-piece) casing, on the outside of which the two electric connectors are arranged, and/or which (completely) encloses the remaining components of the electronics and/or forms a partial casing of the magnetic-valve unit casing. The casing of the electronic unit preferably forms the magnetic-valve unit casing as a common, composite casing together with the magnetic valve or a casing (or partial casing) of the magnetic valve.

In the magnetic valve unit according to the invention the electronic unit is advantageously arranged in immediate spatial proximity to the magnetic valve or its magnetic coil, so that the electric supply lines between the electronic unit and the magnetic coil are advantageously short. The electric supply lines between the electronic unit and the magnetic coil extend preferably completely within the magnetic-valve unit casing here.

The magnetic valve comprises or consists in a manner known per se of a valve section and an actuator section or magnet actuator section, wherein the actuator section mechanically actuates or drives the valve or fluid valve of the valve section via an actuating element that is movable, for example linearly, along a longitudinal axis of the magnetic valve. The magnetic valve is further preferably provided to be operated in (exactly) two different switching positions, which particularly preferably coincide with end positions of the actuator or the actuating element. The magnetic valve is correspondingly preferably a 2/2 switch valve. The valve is further preferably a seat valve, in which a sealing element that is movable (by the actuating element) interacts with a stationary seal seat. The two switching positions are then formed on the one hand by the close position of the valve (in which the sealing element engages in sealing manner on the seal seat and the valve is closed) and on the other hand by the open position of the valve (in which the sealing element and the seal seat are mutually spaced apart and the valve is open). The sealing element or the seal seat preferably consists of an elastomer and/or is configured as a single-piece elastomer component.

The actuator or the actuator section of the magnetic valve comprises the magnetic coil and a magnetic or iron circuit which has a stationary magnetic core, as well as an (axially) movable magnetic armature. The magnetic armature here forms part of the actuating element and is coupled immediately and/or fixedly connected (via a non-magnetic plunger) to the sealing element for the mechanical actuation of the valve. In the simplest case the magnetic armature forms the (complete) actuating element, a front side of the magnetic armature forms the sealing element and the seal seat is formed by a (single-piece) elastomer component.

In a preferred embodiment the electronic unit is arranged
on a longitudinal axis of the magnetic coil (i.e. the longitudinal axis of the magnetic coil extends through the electronic unit), and/or
on an axial front side of the magnetic valve, in particular of the actuator section or of the magnetic coil of the magnetic valve, and/or
on a radial outer side of the magnetic valve or of the magnetic coil of the magnetic valve, and/or
on a side facing away from the fluid connectors of the magnetic valve, in particular the axial front side, of the magnetic valve.

In the simplest case the magnetic valve is a monostable valve, i.e. an NO valve (normally open, open in currentless state) or an NC valve (normally closed, closed in currentless state). The magnetic armature, which is usually arranged completely or partially on the inside of the magnetic coil, upon energization of the magnetic coil is urged in the direction of the stationary magnetic core, i.e. in the direction of a small or smaller axial air gap or working air gap between the magnetic armature and the magnetic core. The magnetic valve further comprises a mechanical return element or spring element, for example a helical spring, which urges the magnetic armature in the opposite direction and thus away from the magnetic core, i.e. in the direction of a great or greater air gap between the magnetic armature and the magnetic core. The actuating element or the magnetic armature can be shifted between an unenergized switching position and/or end position (also referred to as start position) with a great or maximal air gap and an energized switching position and/or end position (also referred to as working position) with a small or minimal air gap. The axial air gap (when assuming the energized end position) is usually greater than zero and preferably is in the range between 0.1 mm and 1.5 mm and/or amounts to, for example, 0.1, 0.2, 0.3, 0.5, 0.7, 0.8, 0.9, 1.0, 1.1, 1.2, 1.3 or 1.5 mm, wherein each of the values mentioned can also represent an upper or lower limit of the range of values mentioned.

In an NO valve, the unenergized end position of the magnetic armature is determined or defined by a mechanical stop and the energized end position is determined or defined by the engagement as intended of the sealing element on the seal seat, i.e. by the close position of the valve, and the two end positions form the provided switching positions of the magnetic valve. In an NC valve, the energized end position of the magnetic armature is determined or defined by a mechanical stop and the unenergized end position is determined or defined by the engagement as intended of the sealing element on the seal seat, i.e. by the close position of the valve, and the two end positions form the provided switching positions of the magnetic valve.

In such a monostable valve the mechanical return or spring element (without energization of the magnetic coil) holds the magnetic armature in the unenergized end position (start position). Upon sufficient energization with a (short-term) switching current (for example 2 A during 300 ms) of the magnetic coil, the magnetic force arising between the magnetic armature and the magnetic core overcomes the spring force of the mechanical spring element and the magnetic armature is shifted into the energized end position (working position), in which is preferably held with a smaller (lasting or continuous) holding current (for example 0.5 to 1 A). After switching off the holding current, the valve returns to the unenergized end position by means of the mechanical return or spring element.

The electronics of the magnetic valve unit in this valve variant is preferably set up to deliver a so-called push-hold energization, i.e. to generate and/or emit to the magnetic valve or the magnetic coil of the magnetic valve the switching current for approaching the working position of the magnetic valve. The switching current is typically in the range of 1.5 A to 10 A and is typically emitted over a period of between 100 ms and 1000 ms (push phase). The electronics is preferably additionally set up to generate or emit a holding current or lasting current for holding the working position. The holding current is typically in the range between 0.5 and 1.5 A (hold phase).

In a preferred, alternative embodiment, the magnetic valve is executed as a bistable valve, i.e. the magnetic valve (or the magnetic armature and/or the actuating element) remains in the most recently approached switching position respectively, which is usually at the same time an end position of the magnetic valve, also in an unenergized state or without holding current. Such a switch valve is known, for example, from DE 10 2011 078 104 A1, and the construction and operation of the bistable magnetic valve disclosed there is incorporated into the disclosure content of the present document, in particular paragraphs [0009] et seq. and FIGS. 1 and 2. In such a bistable magnetic valve there is arranged in the magnetic or iron circuit of the magnetic valve or of the actuator section preferably exactly or at least one permanent magnet which generates a magnetic flow in the magnetic circuit which, after approaching the working position, holds the magnetic armature in the switching position with a small air gap also without energization. In a bistable magnetic valve thus the differentiation between NO and NC valve is canceled, since either switching position or end position can be held stably in a currentless state.

The permanent magnet can be arranged here in the magnetic armature or in the stationary magnetic core. In the simplest case, the permanent magnet is a single-piece, ring-shaped, for example axially magnetized permanent magnet. Alternatively, as the permanent magnet also several, for example ring-segment shaped permanent magnet segments can be provided, whereby the assembly of the magnetic valve is simplified. Said permanent magnet segments are, for example, arranged directly adjoining each other and in a ring shape, so that there results a multi-piece permanent magnet ring. Alternatively, the permanent magnet segments can also be spaced apart from each other.

Such a bistable magnetic valve correspondingly has a first switching position with a great or greater air gap, which is held by the mechanical spring element, and a second switching position with a small or smaller air gap, which is held by the magnetic flow of the permanent magnet.

The electronics of the magnetic valve unit in this bistable magnetic valve variant is preferably set up to deliver (only) a so-called push energization for changing the switching positions, i.e. for example a switching current as described above. The switching currents for approaching the two different switching positions usually have different polarities. In the simplest case, the intensity and the duration of the switching current for approaching the first switching position and for approaching the second switching position is identical, and merely the polarity is different. Generally, the switching currents for approaching the two switching positions are not only different with respect to the polarity, however, but also with respect to (absolute) current intensity or duration, since for approaching the different switching positions usually different amounts of energy are required.

Employing a bistable magnetic valve has the advantage (in comparison to a monostable valve) that the electronics does not have to generate a holding current any more, but only the briefly applied switching current. The electronics can therefore be provided with less effort, i.e. with less powerful components, since there occurs only a short-time energetic loading. In addition, there occurs a small energy consumption and only a correspondingly reduced heat generation, which permits a space-saving construction of the electronics or the electronics unit, facilitates constructive integration of the electronics in the magnetic valve unit and thus saves construction space. The switching current is—as already mentioned—typically in the range from 1.5 A to 10 A, preferably between 1.5 A and 3 A, and amounts to, for example, 1.5 A, 2 A, 3 A, 4 A, 5 A, 7 A or 10 A, wherein each of the values mentioned can also represent an upper or lower limit of the range of values mentioned. The switching current is typically emitted over a period of between 100 ms and 1000 ms, wherein the electronics is presently further set up to generate or emit respectively switching currents with different polarities and preferably also different (absolute) current intensities and/or durations.

Employing a bistable magnetic valve in the magnetic valve unit according to the invention offers advantages and new application aspects not only in regular operation, but also when a failsafe state or failsafe case is present or occurs (for example loss of the supply voltage, external operation disturbance, cable break, system failure, on-board network failure, etc.). This applies in particular in the case of using the magnetic valve unit according to the invention in safety-critical applications, such as in a pneumatic spring or a shock absorber of a vehicle, where a closed magnetic valve causes a hard spring characteristic of the pneumatic spring and an open magnetic valve a soft spring characteristic.

So far, only 2/2 on/off NO switch valves are employed there as a lockable connection between the chambers or air volumes of a pneumatic spring. This employment of NO valves results from considerations with respect to energy consumption of the magnetic valves in representative driving operation. However, the pneumatic spring in the (unenergized) failsafe state is then in the soft and thus more driving-critical state. With respect to driving safety, however, it would be desirable that the pneumatic spring adopts the hard spring characteristic in the failsafe state, that is the magnetic valve is closed. This request cannot be fulfilled with the currently employed NO valves. In order to cover this case, it would be required to employ an NC valve, which is conceivable at best for vehicles in which the hard spring characteristic is employed also in regular operation.

Employing a bistable magnetic valve in the magnetic valve unit according to the invention now creates the preconditions for being able to fulfill all above-mentioned requests with respect to the failsafe state.

As mentioned, without active switching impulse or switching or holding current a bistable magnetic valve remains in the respectively most recently approached switching position. In the failsafe case, i.e. for example upon failure of the supply voltage, the magnetic valve is intended, however, to adopt a predetermined switching position (out of the two or different switching positions of the magnetic valve), which is referred to as failsafe position or failsafe switching position in the following. In principle, both the first or also the second switching position can form the failsafe position or be provided as the failsafe position.

In order to be able to adopt the provided failsafe position also in the failsafe case or upon or after the occurrence of the failsafe state, in particular upon loss of the supply voltage, the electronics preferably has an energy storage, which is set up to store and/or make available to the electronics at least a failsafe energy or failsafe energy amount. The failsafe energy is the energy amount which is required for the electronics to generate at least or exactly once a failsafe energization, i.e. the switching current required for approaching the failsafe position (from the other switching position). The electronics is correspondingly set up to generate and emit to the magnetic valve or the magnetic coil a failsafe energization on the basis of the electric energy or failsafe energy stored in the energy storage. The energy storage is preferably also set up to make available the required energy for operating the electronics or a control logic, so that, for example, at least one failsafe procedure (see below) can be carried out. The magnetic valve unit can thus act autonomously and can ensure approaching and holding the failsafe position in the failsafe case also in the event of a failure of the supply voltage. The failsafe energization in the simplest case is identical to the switching current for approaching the switching position provided as the failsafe position.

The energy storage can in principle be a (rechargeable) battery or generally a chemical accumulator. However, the energy storage is preferably a capacitor or generally an arrangement (in particular a parallel circuit) of several capacitors. A (total) storage capacity of the capacitor (or of the capacitor arrangement) is preferably in the range between 1000 and 5000 μF, preferably between 3000-4000 μF, and amounts to, for example, 1000, 2000, 3000, 4000 or 5000 μF, wherein each of the values mentioned can also represent an upper or lower limit of the range of values mentioned. To the capacitor, there is preferably applied (directly) the supply voltage, i.e. 12 V, 24 V or 48 V.

In order to minimize the storage size of the capacitor and thereby the component costs, preferably the first switching position of the magnetic valve (with a great or greater air gap), which is held by the mechanical spring element, is provided as the failsafe position, since said position usually can be approached with a smaller switching current or at a lower energy input than the second switching position.

In a preferred embodiment the electronics is set up to carry out a failsafe procedure or failsafe sequence of steps (i.e. a failsafe procedure is implemented in the electronics) and to start or trigger the same in the failsafe case upon or after the occurrence of the failsafe state.

In a first preferred variant the electronics is set up so that the failsafe procedure merely comprises or consists of the (unconditional) emission of the failsafe energization to the magnetic coil of the magnetic valve. The failsafe energization is emitted to the magnetic valve in any case and unconditionally, i.e. the failsafe procedure preferably comprises only one single step. Thereby, (depending on the previous switching position) either the failsafe position is approached (when the magnetic valve had not been located in the failsafe position) or is merely maintained (when the magnetic valve had already been located in the failsafe position). In any case, it is ensured thereby that the magnetic valve assumes the desired failsafe position after execution of the failsafe procedure.

In a second preferred variant, the electronics comprise a switching-position recognition device and the electronics is set up such that the failsafe procedure (with the aid of the switching-position recognition device) initially recognizes the current switching position of the magnetic valve. The electronics is further set up such that the failsafe procedure is either terminated or aborted (without further step) when it is recognized that the magnetic valve is already located in the failsafe position, so that no emission of the failsafe energization takes place, or that the failsafe energization is emitted when it is recognized that the magnetic valve is not located in the failsafe position. The electronics is thus set up such that only a conditional failsafe energization takes place in dependence on the switching position upon occurrence of the failsafe state. Correspondingly, the switching current or the failsafe energization is only generated by the electronics when the magnetic valve is not (yet) located in the failsafe position upon occurrence of the failsafe state. By this conditional emission of the failsafe energization the energy consumption and the loading of the electronics of the magnetic valve unit can be reduced.

The electronics and/or the switching-position recognition device in a preferred first embodiment variant is set up to recognize the switching position of the magnetic valve on the basis of a most recently (before occurrence of the failsafe state) emitted switching current, in particular on the basis of the polarity of the most recently emitted switching current. In a preferred second embodiment variant of the switching-position recognition device, the electronics and/or the switching-position recognition device is set up to recognize the switching position of the magnetic valve on the basis of ascertaining the inductance of the magnetic coil of the magnetic valve. This second embodiment variant uses the fact that the inductance of the magnetic coil in the first switching position with a great air gap or open magnetic circuit differs from the inductance in the second switching position with a small air gap or with a closed magnetic circuit. Both variants have the advantage that for recognizing the switching position of the magnetic valve no position sensor is required, whereby component and assembly effort is saved. Correspondingly, the magnetic valve and the magnetic valve unit preferably do not have a position sensor for recognizing the switching position of the magnetic valve or of the magnetic armature.

In the simplest case the electronics is set up to start or trigger the failsafe procedure on the basis of a failsafe signal of a superordinate control device or of an external valve control device, i.e. on the basis of an external control signal, which is usually received via the control connector. However, in order to be able to also recognize disturbances at the control connector or in the control line, in a particularly preferred variant the electronics has a failsafe recognition device (for autonomous diagnosis of a failsafe case). The failsafe recognition device is correspondingly set up to autonomously recognize a failsafe state, i.e. a failsafe case or the occurrence or presence of a failsafe state, and to trigger the failsafe procedure in the failsafe case. The failsafe recognition device recognizes as a failsafe state preferably a failure or a disturbance of the supply voltage, a failure or disturbance on the control connector and/or in the control line or the bus or the communication with a superordinate control device, or a cable break, a system failure, an on-board network failure, etc.

In a preferred embodiment the electronics is set up to emit the failsafe energization upon or immediately after the supply voltage is switched on. The magnetic valve is thereby brought into a defined switching position, namely the failsafe position, upon starting or re-starting the system (for example upon starting a vehicle, within the meaning of an initialization).

In a further preferred embodiment the switching-position recognition device recognizes (in particular via ascertaining the inductance) the switching position of the magnetic valve at regular (short) intervals of, for example, 1 to 10 seconds, whereby a permanent and optionally redundant monitoring of the current switching position of the magnetic valve is created.

In a preferred embodiment the electronics of the magnetic valve unit—as an alternative or in addition to the above-described drive electronics—has one, two or several sensors, for example one or several pressure sensor(s) and/or an acceleration sensor and/or a temperature sensor, or consists thereof. In the simplest case, the electronics comprises exactly one or two pressure sensor(s) or consists thereof. By the constructive integration according to the invention of the electronics within or into the magnetic valve unit thereby the corresponding measuring values (pressure, acceleration, temperature, etc.) can be detected and made available immediately at the location of use of the magnetic valve unit. The sensors thus deliver valuable operative information and at the same time form part of the electronics and thus also of the pre-assembled or compact construction group of the magnetic valve unit, so that no additional assembly effort occurs. The measuring values of the respective sensors are advantageously made available at the (already present) control connector, so that no additional assembly or wiring effort is created here and no additional components are required. The sensors are advantageously arranged within the magnetic-valve unit casing, so that the sensors are protected at the same time.

In a preferred embodiment the electronics is configured as an electronics unit with exactly one or several circuit boards, and the sensor(s), i.e. all optionally present pressure, acceleration and/or temperature sensors, are arranged on the circuit board(s) together with the remaining components of the electronics.

The magnetic valve unit preferably has a first and/or second pressure supply line, which pneumatically or hydraulically connects the first and/or second pressure sensor respectively with the two fluid connectors of the magnetic valve.

The first fluid connector is an axial fluid connector and the magnetic valve is preferably a pressure-balanced valve, i.e. an actuator space, comprising the magnetic armature and the magnetic core, is pneumatically or hydraulically connected to an axial valve space or the axial fluid connector. The magnetic valve has, for example, a continuously hollow plunger or other pressure passages, with which the pressure from the axial fluid connector is guided into the actuator space, and thus, for example, to the “back side” of the magnetic armature and/or the magnetic core. The actuator space thus extends advantageously up to a side of the magnetic coil of the magnetic valve facing the electronics unit and/or up to or into the proximity of the front side of the magnetic valve facing away from the fluid connectors. The first pressure supply line then preferably leads from the first pressure sensor to the actuator space.

The second fluid connector is a radial fluid connector. Additionally or alternatively, the second pressure supply line leads from the second pressure sensor into a valve space of the radial fluid connector.

In a preferred embodiment the magnetic valve unit has a first outer, elastomeric sealing ring, which is arranged on an outer side of the magnetic valve between the first and the second or between the axial and the radial fluid connector, so that the magnetic valve unit can seal or will seal, when employed as intended, with the aid of the first sealing ring, a first or axial fluid or pneumatic chamber (or the one communicating with the magnetic valve via the axial fluid connector) against a second or radial fluid or pneumatic chamber (or the one communicating with the magnetic valve via the radial fluid connector).

Alternatively or additionally, the magnetic valve unit has a second outer elastomeric sealing ring, which is arranged, for example, on the side of the radial fluid connector disposed opposite the first sealing ring, so that the magnetic valve unit can seal, with the aid of the second sealing ring, the second, radial fluid or pneumatic chamber, for example against an outer side or the atmosphere. The second sealing ring is preferably arranged (circumferentially) on an outer side of the casing of the electronic unit and/or spaced apart from the magnetic valve.

Preferably the second pressure supply line leads from the second pressure sensor of the electronics to the outer side of the magnetic-valve unit casing, to a location which is disposed axially between the first and the second sealing ring, or in the region of the second or radial fluid or pneumatic chamber. Particularly preferably the second pressure supply line leads to a location on the outer side of the casing of the electronic unit which is disposed (axially) between the second sealing ring and the magnetic valve.

The invention further relates to a pneumatic spring, in particular a multi-chamber pneumatic spring with a magnetic valve unit as described above, comprising a first and a second air volume or a first and a second pneumatic chamber, which are pneumatically connected in lockable manner via the magnetic valve unit.

The pneumatic chambers are preferably mutually adjacent and/or at least one pneumatic chamber is arranged on the outer side of the pneumatic spring, and respectively have openings towards each other and towards the outer side or the atmosphere, which are closed in sealing manner by the magnetic valve unit or the magnetic-valve unit casing (and the sealing rings optionally arranged thereon). The magnetic valve unit can thus be plugged into the pneumatic spring or into the predetermined openings of the pneumatic spring, which simplifies the assembly of a switch valve or of the magnetic valve unit of the pneumatic spring. The fluid connectors of the magnetic valve of the magnetic valve unit are preferably formed by simple openings, since a sealing takes place, for example, already by the magnetic-valve unit casing and the sealing rings on the outer side thereof.

For example, the first air volume forms the so-called base volume of the pneumatic spring here, in which a spring piston is shifted. This base volume can be expanded by the second air volume (additional volume) via the magnetic valve unit, whereby a common air volume is created, which leads to softer spring characteristics than the base volume only. The hard spring characteristics of the base volume only usually form the failsafe setting, for which reason the failsafe position of the magnetic valve unit is the close position in this application.

In the pneumatic spring exactly one additional volume (two-chamber pneumatic spring) or also two additional volumes (three-chamber pneumatic spring) or even more additional volumes can be provided, which can then be connected selectively and/or are of different dimensions.

The invention further relates to a pneumatic spring system of a vehicle or motor vehicle, comprising one of several magnetic valve units as described above or one or several pneumatic springs as described above.

### BRIEF DESCRIPTION OF THE DRAWINGS

The invention will hereinafter be described by way of example with reference to the attached drawings. The drawings are merely schematic representations and the invention is not limited to the specific represented embodiment examples.

FIG. 1 shows a sectional view of a magnetic valve unit, and

FIG. 2 shows a sectional view of a pneumatic spring.

### DETAILED DESCRIPTION

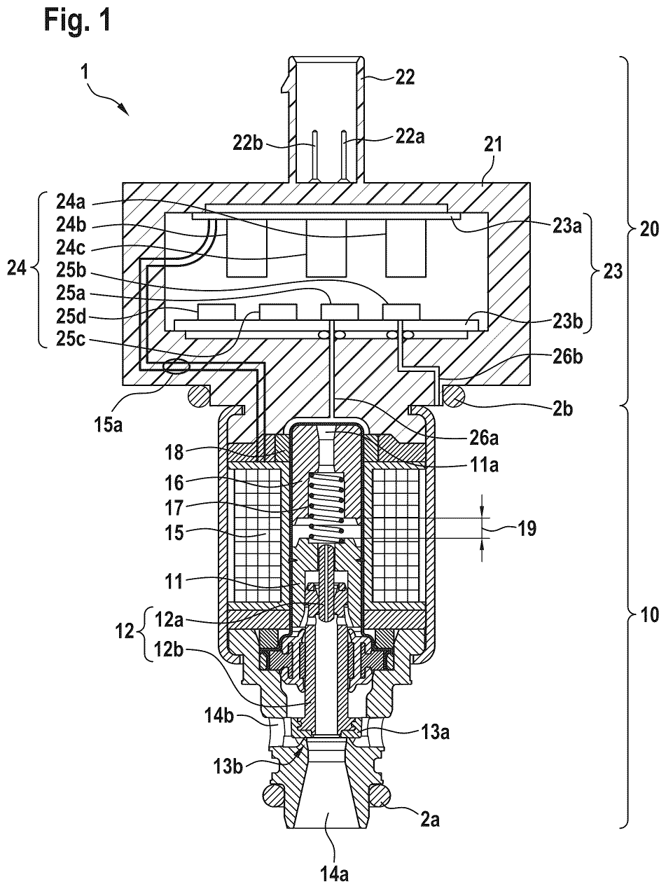

FIG. 1 shows a sectional view through an embodiment example of the magnetic valve unit 1 according to the invention. Said unit comprises a magnetic valve 10 already known in principle, which is constructed as a bistable seat valve, as described, for example, in DE 10 2011 078 204 A1. The magnetic valve 10 comprises a linearly movable magnetic armature 11, which is fixedly connected via a hollow plunger rod 12a and a hollow plunger 12b (in the following referred to as plunger 12) to an elastomeric sealing element 13a. In the switching position or end position shown in FIG. 1 the sealing element 13a engages in sealing manner on the seal seat 13b (close position), thus locking the axial fluid connector 14a against the radial fluid connector 14b. The magnetic valve 10 further comprises a magnetic coil 15, upon the energization of which the magnetic armature 11 is urged in the direction of the stationary magnetic core 16, overcomes the return force of the spring element 17 upon sufficient energization and is shifted from the first switching position with a great air gap 19 (close position) represented in FIG. 1 to a not represented second switching position with a small air gap 19 (open position).

The magnetic or iron circuit formed around the coil 15 in the magnetic valve 10 among other things by the magnetic armature 11 and the magnetic core 16 and further magnetically soft or ferromagnetic elements (transition disk, external magnetic closing element, etc.) further comprises a permanent magnet 18, which is presently configured as an axially magnetized ring and consists of a multiplicity of mutually abutting ring segments. Thereby sufficient magnetic force is generated in the second switching position between the magnetic armature 11 and the magnetic core 16 also without energization, so that the magnetic valve remains in the (not represented) open position. Only when an energization is applied that weakens the magnetic flow of the permanent magnet 18, also the magnetic attraction force between the magnetic armature 11 and the magnetic core 16 is weakened, so that the magnetic armature 11 is shifted to the close position represented in FIG. 1. In a not represented embodiment example the magnetic valve 10 is constructed such that the close position of the valve is assumed with a small air gap 19.

The magnetic valve unit 1 comprises, besides the magnetic valve 10, also an electronic unit 20, which is arranged on and fixedly connected to an axial front side of the magnetic valve 10 that is adjacent to the magnetic coil 15. The electronic unit 20 comprises a closed casing 21 and a supply voltage connector 22a and a control or bus connector 22b. These are realized as a common electric connector 22 in the represented embodiment example. Within the closed casing 21 two circuit boards 23a, 23b are arranged, which, in a not represented embodiment example, can be realized also as one single circuit board 23, however, and which are referred to as circuit board 23 in the following. On the circuit boards 23a, 23b or the circuit board 23, the different electric and electronic components of the electronics 24 are located, which is thus integrated in the electronic unit 20 or the magnetic valve unit 1. The integrated electronics 24 comprises a control logic 24a, a power electronics 24b, an energy storage 24c, and a first and a second pressure sensor 25a, 25b, an acceleration sensor 25c and a temperature sensor 25d. For the energization of the magnetic coil 15 there extend two single-core supply lines 15a between the circuit board 23 or the power electronics 24b and the magnetic coil 15. The supply lines 15a form the only electric supply lines of the magnetic valve 10 at the same time.

Further, the electronic unit 20 or optionally also the magnetic valve 10 comprises pressure supply lines 26a, 26b, which pneumatically link respectively the first and second pressure sensor 25a, 25b to the pressure to be measured respectively. The first pressure sensor 25a is provided to detect the pressure at the axial fluid connector 14a. Correspondingly, the first pressure supply line 26a extends into the actuator space in which the magnetic armature 11 and the magnetic core 16 are located, and which is pneumatically connected to the axial fluid connector 14a, since the plunger 12 is continuously hollow and the magnetic valve 10 is a pressure-compensated valve. The second pressure sensor 25b is provided to detect the pressure at the radial fluid connector 14b. In the represented embodiment example, this pressure is not present only on the radial fluid connector 14b itself, but also on a part of the outer side of the casing 21. Correspondingly, the second pressure supply line 26b extends from the second pressure sensor 26b to a location on the outer side of the casing 21 of the electronic unit 20, which is disposed axially between the sealing ring 2b placed circumferentially on the casing 21 of the electronic unit 20 and the magnetic valve 10.

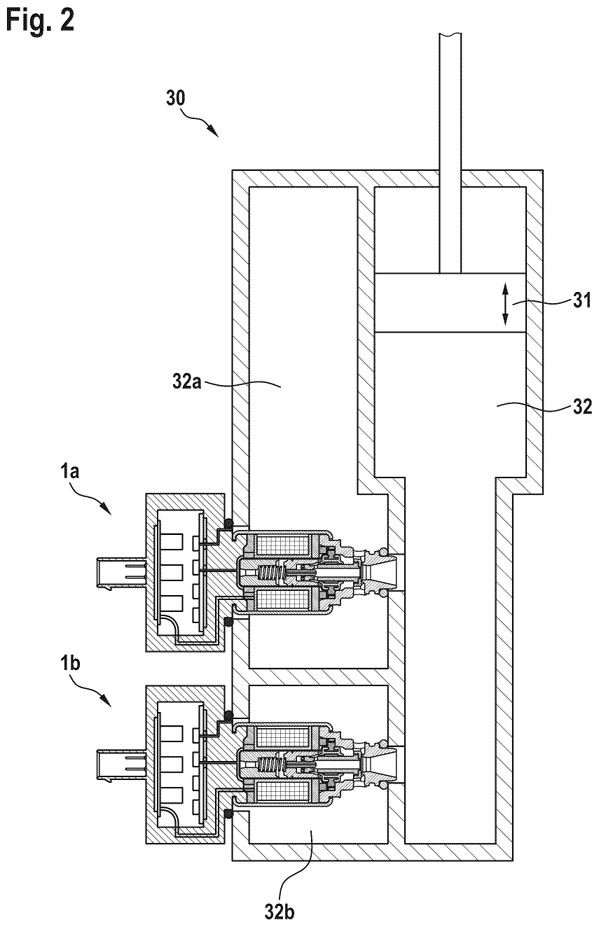

In FIG. 2 a pneumatic spring 30 or an air strut is represented with a spring piston 31 which moves linearly in a cylindrical section of the base volume 32. The base volume 32 is connected in lockable manner via a first magnetic valve unit 1a to a first additional volume 32a. The opening between the pneumatic chamber of the base volume 32 and the pneumatic chamber of the first additional volume 32a is closed in sealing manner with the aid of the magnetic valve device 1a and its circumferential sealing ring 2a. Further, the pneumatic chamber of the first additional volume 32a is sealed against the outer side or the atmosphere by the magnetic valve device 1a and the circumferential sealing ring 21b.

The pneumatic spring 30 further comprises a second additional volume 32b, the pneumatic chamber of which is in turn connected in sealing and lockable manner with respect to the base volume 32 with the aid of the second magnetic valve device 1b. Likewise, the pneumatic chamber of the second additional volume 32b is also sealed against the outer side with the aid of the second magnetic valve device 1b. The connectible second additional volume 32b is smaller here than the connectible first additional volume 32a and both additional volumes 32a, 32b can be connected to the base volume 32 selectively and electively independently from each other.

### LIST OF REFERENCE NUMERALS

1, 1a, 1b magnetic valve unit
2a, 2b sealing ring
10 magnetic valve
11 magnetic armature
11a actuator space
12 plunger
12a plunger rod
12b hollow rod
13a sealing element
13b seal seat
14a axial fluid connector
14b radial fluid connector
15 magnetic coil
15a electric supply lines
16 magnetic core
17 return spring
18 permanent magnet
19 air gap, working air gap
20 electronic unit
21 casing
22 electric connector
22a supply voltage connector
22b control connector, bus connector
23, 23a, 23b circuit board
24 electronics
24a control logic, switching position, failsafe recognition device
24b power electronics
24c energy storage, capacitor
25a, b first, second pressure sensor
25c acceleration sensor
25d temperature sensor
26a, b first, second pressure supply line
30 pneumatic spring
31 spring piston
32 base volume
32a, 32b first, second additional volume

1. A magnetic valve unit comprising a magnetic valve and an electronics which is preferably set up for driving the magnetic valve and/or comprises a sensor, particularly preferably a pressure sensor.

2. The magnetic valve unit according to claim 1, comprising a casing which is preferably a closed casing, wherein the magnetic valve unit and/or the casing has two fluid connectors and/or two electric connectors, preferably a supply voltage connector and a control connector.

3. The magnetic valve unit according to claim 1, wherein
electric supply lines of the magnetic valve lead to the electronics, and/or
the magnetic valve has a magnetic coil and the electronics is set up to emit and/or generate a coil current, and/or
the electronics is electrically immediately connected to the magnetic coil of the magnetic valve, and/or
the electronics has a control logic and/or a power electronics, and/or
the electronics is set up to apply the supply voltage to the magnetic coil of the magnetic valve, and/or
exactly two single-core electric supply lines extend between the electronics and the magnetic valve and/or the magnetic coil of the magnetic valve.

4. The magnetic valve unit according to claim 1, wherein the electronics is configured as an electronic unit,
which preferably has a circuit board on which the components of the electronics, in particular integrated electronic construction elements, are arranged, and/or
which preferably has a casing and preferably forms the casing of the magnetic valve unit together with the magnetic valve, and/or
which preferably is fixedly connected to the magnetic valve, and/or
which preferably is arranged on a longitudinal axis of the magnetic coil and/or on an axial front side of the magnetic valve, in particular of an actuator or of the magnetic coil.

5. The magnetic valve unit according to claim 1, wherein
the magnetic valve is an NO or an NC valve, or
the magnetic valve is a bistable magnetic valve, which preferably has a permanent magnet in a magnetic circuit of the magnetic valve, and/or
the magnetic valve is a switch valve, a seat valve and/or a 2/2 valve, and/or
the magnetic valve has a first switching position with a great air gap and a second switching position with a small air gap,
wherein a failsafe position is formed preferably by the first switching position, which is particularly preferably a close position of the magnetic valve.

6. The magnetic valve unit according to claim 1, wherein
the electronics comprises an energy storage, which is set up to store and/or make available to the electronics a failsafe energy, and/or
the electronics is set up to generate a failsafe energization on the basis of the failsafe energy and to emit it to the magnetic valve, and/or
the energy storage is formed by a capacitor, which preferably has a capacity between 1000 and 5000 μF.

7. The magnetic valve unit according to claim 6, wherein the electronics is set up to start or trigger a failsafe procedure in the failsafe casing,
either comprising
emitting the failsafe energization,
or comprising
recognizing the switching position of the magnetic valve, preferably with the aid of a switching-position recognition device,
terminating the failsafe procedure when the recognized switching position is the failsafe position, and/or
emitting the failsafe energization when the recognized switching position differs from the failsafe position,
wherein the switching-position recognition device is set up to recognize the switching position of the magnetic valve on the basis of a most recently emitted switching current and/or on the basis of ascertaining an inductance of the magnetic coil.

8. The magnetic valve unit according to claim 7, wherein
the electronics is set up to trigger the failsafe procedure on the basis of a failsafe signal of a superordinate control device, and/or
the electronics has a failsafe recognition device which is set up to recognize a failsafe state and to trigger the failsafe procedure,
wherein as the failsafe state preferably a failure or a disturbance of the supply voltage and/or a failure or a disturbance on the control connector is recognized.

9. The magnetic valve unit according to claim 6, wherein
the electronics emits the failsafe energization upon switching on the supply voltage and/or the switching-position recognition device recognizes the switching position at regular intervals.

10. The magnetic valve unit according to claim 1, wherein the electronics comprises one or several sensors, in particular one or two pressure sensors and/or an acceleration sensor and/or a temperature sensor, wherein the electronics is preferably set up to make available sensor measuring values at the sensor connector.

11. The magnetic valve unit according to claim 10, wherein the sensor or the sensors is/are arranged on the circuit board.

12. The magnetic valve unit according to claim 10, wherein the magnetic valve unit has a first and/or a second pressure supply line, which pneumatically or hydraulically connects a first and/or second pressure sensor respectively to a first or second fluid connector of the two fluid connectors,
wherein the first fluid connector is an axial fluid connector, the magnetic valve is preferably a pressure-compensated valve and preferably the first pressure supply line leads from the first pressure sensor of the electronics into the actuator space, and/or
wherein the second fluid connector is a radial fluid connector and preferably the second pressure supply line leads from the second pressure sensor of the electronics into a valve space of the radial fluid connector.

13. The magnetic valve unit according to claim 10, wherein
the magnetic valve unit has a first outer sealing ring, which is arranged between the axial and the radial fluid connector, and/or
the magnetic valve unit has a second outer sealing ring, which is arranged on the side of the radial fluid connector disposed opposite the first sealing ring,
wherein preferably the second pressure supply line leads from the second pressure sensor of the electronics to the outside of the casing of the electronic unit.

14. A pneumatic spring, in particular a multi-chamber pneumatic spring with a magnetic valve unit according to claim 1, comprising a first and a second pneumatic chamber, which are pneumatically connected in a manner lockable via the magnetic valve unit, wherein the pneumatic chambers are preferably arranged adjacently and/or respectively have openings which are closed in sealing manner by the magnetic valve unit.

15. A pneumatic spring system of a vehicle, comprising one or several magnetic valve units according to claim 1.
